(19) United States
(12) Patent Application Publication
(10) Pub. No.: US 2008/0045317 A1
(43) Pub. Date: Feb. 21, 2008

(54) GAMING DEVICE WITH AUTOMATED PLAYER CUSTOMIZATION

(76) Inventors: Jerald C. Seelig, Absecon, NJ (US); Lawrence M. Henshaw, Hammonton, NJ (US)

Correspondence Address: IAN F. BURNS & ASSOCIATES, P.O. BOX 71115, RENO, NV, 89570, US

(21) Appl. No.: 11/838,086

(22) Filed: Aug. 13, 2007

Related U.S. Application Data
(60) Provisional application No. 60/822,185, filed on Aug. 11, 2006.
(60) Provisional application No. 60/895,322, filed on Mar. 16, 2007.

(51) Int. Cl. A63F 13/00

(52) U.S. Cl. 463/20; 463/25; 463/36; 463/43

(57) ABSTRACT

A gaming device includes a game apparatus. The game apparatus allows a player to play a game and has at least one game parameter. A controller is in communication with the game apparatus. The controller is adapted to gather player profile information during game play and to modify the at least one game parameter during game play based upon the player profile information. The player profile information can be gathered without the game player's knowledge.

### CROSS REFERENCE TO RELATED AND CO-PENDING APPLICATIONS

This application claims priority to U.S. provisional patent application Ser. No. 60/822,185, filed Aug. 11, 2006, and U.S. provisional patent application Ser. No. 60/895,322, filed Mar. 16, 2007, the contents of both of which are herein incorporated by reference in their entirety.

### FIELD OF THE INVENTION

The present invention relates to gaming devices and, more particularly, to a gaming device that can automatically change certain features of the gaming device to be customized to a game player's preferences

### BACKGROUND

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number (hereinafter, both types are referred to as a “random number”).

The random number can be used to determine a game outcome. For example, the random number may then be compared to a predefined table to determine a corresponding outcome of the event. If the random number falls within a certain range of numbers on the table, the player may win the corresponding predefined prize. The table may also contain display information that allows the gaming device to generate a display that corresponds to the outcome of the game. The gaming device may present the outcome of the game on a large variety of display devices, such as mechanical spinning reels or video screens.

Some gaming devices award bonus prizes in addition to prizes that are awarded in a primary game. Of course, the prize in the primary game may simply be the opportunity to play the bonus game. A bonus prize is generally defined as a prize in addition to the prize obtained from the primary game and that is awarded to the player when a predefined event occurs. An example of a bonus game can be found in U.S. Pat. No. 5,848,932 to Adams. Adams discloses a primary game having three spinning game reels and a bonus game having a bonus display with one spinning wheel. The spinning wheel is divided into multiple sections, and each section has a symbol representing a prize. When predetermined indicia are displayed on the spinning game reels of the primary game, the wheel of the bonus display spins and stops. The bonus prize is displayed as the symbol on the wheel being pointed to by a pointer. The bonus prize is awarded in addition to any prizes awarded in the primary game. Another bonus game is disclosed in Baerlocher et al. (U.S. Pat. No. 6,336,863). Baerlocher et al. discloses a slot machine with a bonus award display. The bonus award display has a bonus wheel and a mechanical, movable pointer.

Gaming devices in casinos are more successful when they are able to captivate and hold a game player's interest for a long period of time. When a game player plays a gaming device for a longer period of time, more revenue is generated for the casino. A game player may lose interest with a game that has a static display that changes very little over time or that the player deems to be unattractive.

Many different individual game players or patrons visit casinos. Each player that visits a casino is a unique individual and has unique interests and tastes. For example, one player may be more attracted to a gaming device that displays predominately red colors with rock and roll music, and another player may be attracted to a gaming device that displays mainly blue colors with country music. A game or game feature that may be interesting to one player is not necessarily interesting to another player.

Currently, conventional gaming machines that offer games of chance do not take the distinct individual player preferences and interests into account. The same games are presented by the gaming machine, regardless of the player's individual characteristics and interests. Because of the wide variations among player personalities and preferences, only a certain percentage of the games presented by gaming machines are successful in gaining and maintaining player interest.

What is needed is a gaming device that can automatically gather player preference information during the course of game play and modify the gaming device to present a tailored or customized gaming experience to the player to increase and prolong player interest.

### SUMMARY

Advantages

The various embodiments of the present invention may, but do not necessarily, achieve one or more of the following advantages:

provide a highly attractive and entertaining device for conducting games;

provide a highly attractive and entertaining device for displaying prizes;

the ability to attract more patrons to play a game;

the ability to encourage players to play longer on a gaming apparatus;

provide a gaming device that can be customized to a game player's preference;

allow a game player to select a symbol that can display a prize;

allow a game player to select a possible prize to be awarded;

provide a gaming device that can gather information about a game player's preferred game parameters without the game player's knowledge;

provide a game display that creates additional suspense and excitement for players by providing a variable display that changes during the game based upon information gathered from the player;

provide the illusion that the player can influence the outcome of a game; and

provide an additional element of anticipation and excitement for players.

These and other advantages may be realized by reference to the remaining portions of the specification, claims, and abstract.

### BRIEF DESCRIPTION OF CERTAIN ASPECTS OF THE INVENTION

In one embodiment, the present invention comprises a gaming apparatus that allows a player to play a game and has at least one game parameter. A controller is in communication with the game apparatus. The controller is adapted to gather player profile information during game play and to modify at least one game parameter during game play based upon the player profile information.

In at least one alternative embodiment, the present invention is directed to a gaming method. The method includes allowing a game player to play a game on a gaming device. Player preference information is gathered from a game player during the game in a covert manner such that the game player is unaware of the information gathering. The game is modified based upon the player preference information.

The above description sets forth, rather broadly, the more important features of the present invention so that the detailed description of the following preferred and other embodiments may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components as set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Certain embodiments of the invention are shown in the accompanying drawings wherein:

FIG. 1 is substantially a front elevation view of an embodiment of the gaming apparatus of the present invention.

FIG. 2 is substantially a schematic diagram showing components of an embodiment of the gaming apparatus.

FIG. 3 is substantially a front elevation view of the gaming apparatus of FIG. 1 showing an embodiment of a game display.

FIG. 4 is substantially a front elevation view of the gaming apparatus of FIG. 1 showing another embodiment of a game display.

FIG. 5 is substantially a front elevation view of the gaming apparatus of FIG. 1 showing an alternate embodiment of a game display.

FIG. 6 is substantially a front elevation view of the gaming apparatus of FIG. 1 showing yet another embodiment of a game display.

FIG. 7 is substantially a front elevation view of the gaming apparatus of FIG. 1 showing yet another embodiment of a game display.

FIG. 8 is substantially a front elevation view of the gaming apparatus of FIG. 1 showing an additional embodiment of a game display.

FIG. 9 is substantially a front elevation view of the gaming apparatus of FIG. 1 showing another embodiment of a game display.

FIG. 10 is substantially a flowchart of a gaming method of the present invention.

FIG. 11 is substantially a front elevation view of another embodiment of the gaming apparatus of the present invention.

FIG. 12 is substantially a schematic diagram showing components of the gaming apparatus of FIG. 11.

FIG. 13 is substantially a partial front elevation view of the gaming apparatus of FIG. 11 showing an embodiment of a game display.

FIG. 14 is substantially a flowchart of a method according to the present invention.

FIG. 15 is substantially a front elevation view of the gaming apparatus of FIG. 11 showing another embodiment of a game display.

FIG. 16 is substantially a partial front elevation view of the gaming apparatus of FIG. 15 showing an embodiment of a game display.

FIG. 17 is substantially a flowchart of a method according to the present invention.

FIG. 18 is substantially a front elevation view of the gaming apparatus of FIG. 11 showing an additional embodiment of a game display.

FIG. 19 is substantially a partial front elevation view of the gaming apparatus of FIG. 18 showing an embodiment of a game display.

FIG. 20 is substantially a flowchart of a method according to the present invention.

### DESCRIPTION OF AT LEAST ONE EMBODIMENT OF THE PRESENT INVENTION

In the following detailed description of at least one embodiment of the present invention, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

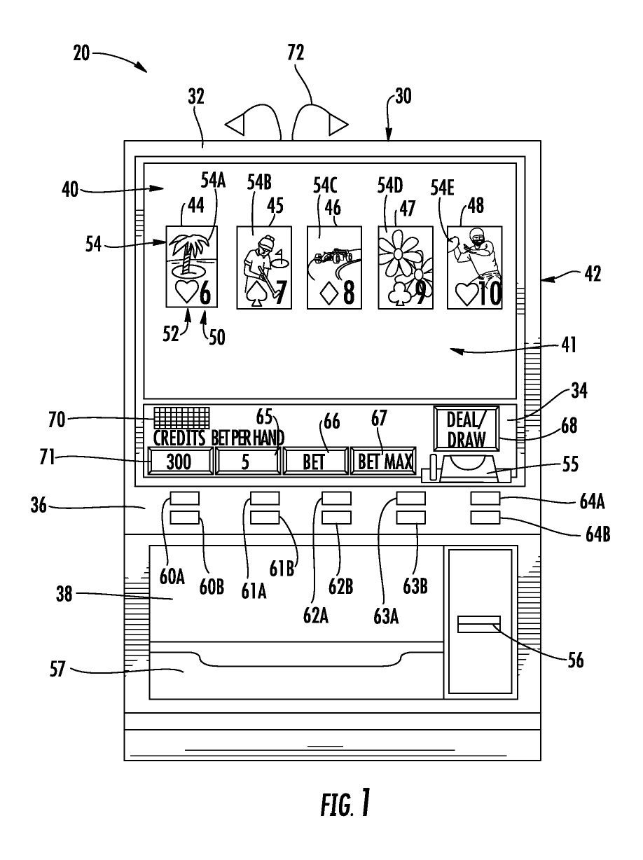

As seen in FIG. 1, the present invention comprises a gaming machine, device or apparatus, generally indicated by reference number 20. In at least one embodiment, gaming apparatus 20 may be any of a large number of devices that are adapted to allow players to play a game, such as gaming devices typically found in arcade and casino environments, including arcade games, video games, gambling machines, video poker machines, slot machines, etc. In at least one embodiment, gaming apparatus 20 is further adapted to allow a player to place a wager and play a game, such as video poker.

Gaming apparatus 20 may include a housing 30 having a front panel 32, button panels 34 and 36 and panel 38. A video display 40 can be mounted to front panel 32. Video display 40 can be any of a large number of conventional display devices such as video displays including CRT, LCD and plasma video displays. Video display 40 can show a wide variety of video presentations. One such display, as shown in FIG. 1, is a video poker display 42 with a background 41. Video poker display 42 can be disposed over background 41. Background 41 can be any suitable video presentation that is attractive and may draw player interest. In FIG. 1, background 41 is blank or empty.

Video poker display 42 has five card positions 44, 45, 46, 47 and 48. One playing card from a standard 52 card playing card deck is displayed in each of card positions 44-48. Each playing card has an associated card value 50 and suit 52.

In addition, each of the five card positions 44, 45, 46, 47 and 48 may display one or more game parameters or attributes such as symbols or themes 54. The parameters, attributes, themes or symbols may be associated with various activities or objects. For example, card position 44 displays a tropical island theme 54A. Card position 45 displays a golf theme 54B. Card position 46 displays a race car theme 54C. Card position 47 displays a garden or flower bed theme 54D. Card position 48 displays a football theme 54E.

Gaming apparatus 20 may further include a device for accepting value (including currency and/or currency equivalents), such as a coin slot 55 and bill acceptor, voucher reader, or value acceptor 56. In order to accrue credits that may be used to play the gaming apparatus 20, the player inserts paper currency or other suitable script or gaming coupons into the value acceptor 56 behind which, on the interior of the gaming machine, is mounted a bill acceptor which takes in and validates the currency. The monetary value of the inserted currency is then applied to the credit meter 71, the credits on which the player may use to play the gaming machine.

A payout mechanism (not shown) and a coin receptacle 57 may be provided for awarding prizes or for dispensing value to players cashing out and retiring from a game. A printer (not shown) may also be provided for printing out cashless vouchers (not shown). A pay table (not shown) may further be provided to allow a player to see what combination of cards provide a winning event.

Button panel 34 can include a credit meter 71 and a display of the “Bet Per Hand” bet button 65 which is the number of credits wagered on each hand for a particular round of play of the game. A DEAL/DRAW button 68 allows the player to cause the initial deal of the cards to be displayed on the video display 40. Other buttons allow the player to make an initial wager, which can be made one credit at a time using the BET button 66 or which can be made by wagering the maximum number of credits allowed by the gaming machine using the BET MAX button 67.

Gaming apparatus 20 also has a button panel 36 which includes selection buttons that the player may press to activate various actions during game play. Button 60A allows the player to keep the card displayed in card position 44. Button 60B allows the player to discard the card displayed in card position 44. Button 61A allows the player to keep the card displayed in card position 45. Button 61B allows the player to discard the card displayed in card position 45. Button 62A allows the player to keep the card displayed in card position 46. Button 62B allows the player to discard the card displayed in card position 46. Button 63A allows the player to keep the card displayed in card position 47. Button 63B allows the player to discard the card displayed in card position 47. Button 64A allows the player to keep the card displayed in card position 48. Button 64B allows the player to discard the card displayed in card position 48.

Instead of using buttons on the button panel, the video display 40 can be provided with touch screen locations (not shown) that the player would touch to select which cards to keep and which to discard.

Gaming apparatus 20 may also include speakers 70 for playing music or announcements and housing lights 72 that may display various colors and light patterns.

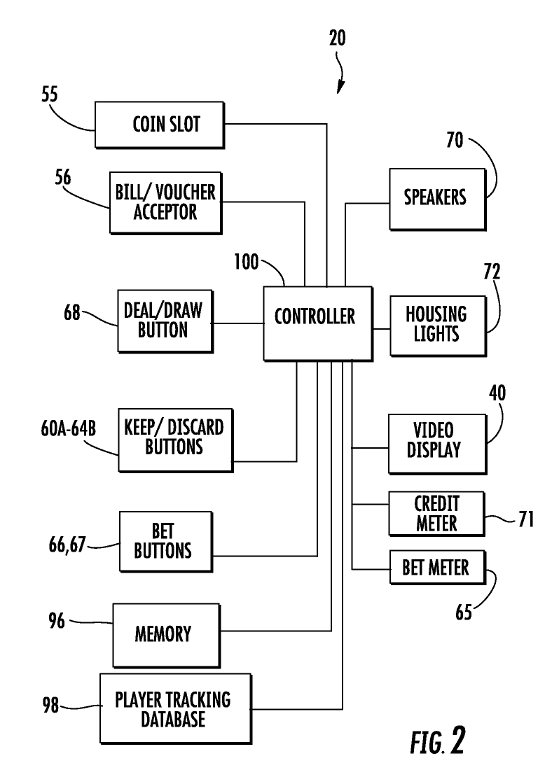

Referring now to FIG. 2, a schematic diagram of some components that may be included in certain embodiments of gaming apparatus 20 are shown. Gaming apparatus 20 may include a coin slot 55 and value acceptor 56 configured to accept value from the player in the form of paper currency, coins, player cards, tickets, vouchers, tokens, or other forms of value. Coin slot 55 and value acceptor 56 may be in communication with a controller 100. Controller 100 may be any suitable controller such as a microprocessor. Controller 100 may be in communication with input devices such as DEAL/DRAW button 68 and BET button 66 and BET MAX button 67. Controller 100 may detect insertion of value into coin slot 55 and value acceptor 56 and may prompt the player to start a game by activating DEAL/DRAW button 68. Once controller 100 senses a signal to start the game, controller 100 may be configured to produce a random number and activate video display 40.

Video display 40 may be configured to display indicia (including symbols, characters, numbers, letters, pictures, playing cards and the like) on video display 40 according to the random number generated by controller 100. Controller 100 may further be configured to determine a game outcome based upon the random number and a predetermined paytable as is known in the art.

Controller 100 can also be in communication with a memory 96 and a player tracking database 98. Memory 96 may comprise a random access memory or a disc drive and may store information generated during game play of gaming apparatus 20. Player tracking database 98 may store historical information about players and their playing habits using player tracking cards as is well known in the industry.

Gaming apparatus 20 could also be implemented in a physical mechanical form. Gaming apparatus 20 is not limited to card games but could be based on other games such as dominoes, roulette, craps, baccarat, and other games.

Gaming apparatus 20 may further include a speaker 70 and housing lights 72. Controller 100 may cause speaker 70 and housing lights 72 to create a festive and lively winning atmosphere to elicit interest and entertainment from both the player and adjacent patrons.

Referring back to FIG. 1, the operation of gaming apparatus 20 will be explained. Initially, a game player makes a deposit into coin slot 55 or value acceptor 56. The credit meter 71 displays the number of credits. Next, the game player would depress DEAL/DRAW button 68 to begin the game. Controller 100 generates a random number and determines the appropriate game outcome. Controller 100 would cause video display 40 to show video poker display 42 including cards in card positions 44, 45, 46, 47 and 48.

Next, the player is allowed to select which cards to keep and which to discard using selection buttons 60A-64B. Controller 100 then deals replacement cards to the card positions that were selected to be discarded. Controller 100 then credits any prizes that correspond to the previously determined game outcome to credit meter 71. At the same time, controller 100 keeps a statistical record in memory 96 of which card themes 54A-E are kept and which card themes 54A-E are discarded. After a pre-determined number of game rounds or hands of video poker, controller 100 determines from the statistical record in memory 96, which of the card themes 54A-E were most often kept.

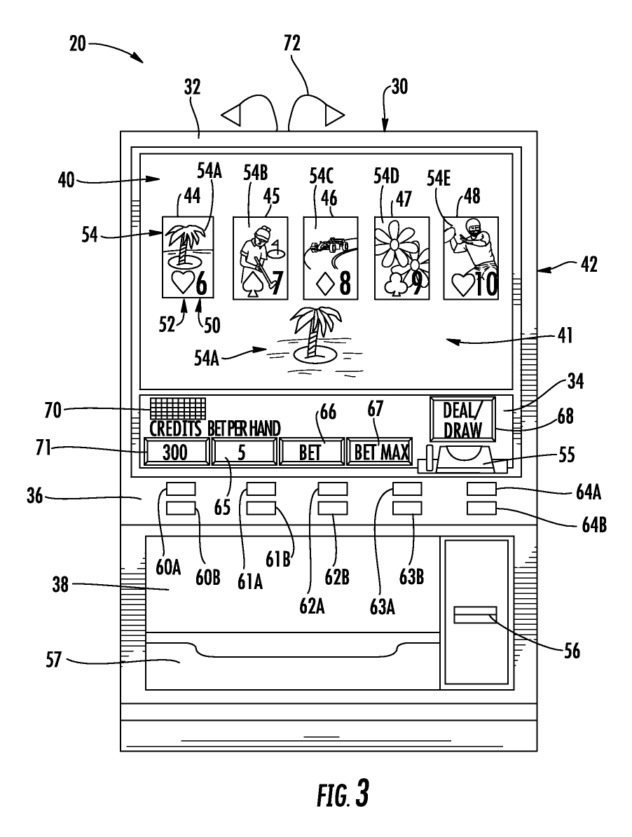

Turning now to FIG. 3, controller 100 (FIG. 2) then causes video display 40 to display in background 41 an image corresponding to the player's preferential theme image. For example, assume that 20 hands of video poker are played on gaming apparatus 20. Controller 100 may record a statistical record of the cards kept as shown in table 1. Table 1 shows that the tropical island theme 54A was kept most frequently.

TABLE 1

| | Number of |
|---|---|
| Card Theme | Times Kept |
| Tropical island theme 54A | 16 |
| Golf theme 54B | 12 |
| Race car theme 54C | 7 |
| Flower bed theme 54D | 5 |
| Football theme 54E | 2 |

Controller 100 then causes video display 40 to display in background 41 tropical island theme 54A corresponding to the player's preferential image. In this manner, various game parameters or attributes of gaming apparatus 20 may be customized to the game player's preferences and desires without the game player's knowledge or awareness that the game is being customized to his or her personal tastes. In this example, the game parameter that is customized is the background image. Therefore, gaming apparatus 20 is able to gather player profile information during game play without the game player's knowledge. In an alternative embodiment, the cards that are discarded could be tracked and used to determine the player's preferred image.

Gaming apparatus 20 can gather player profile information on a wide variety of subjects, player preferences and game parameters. For example, gaming apparatus 20 may gather information related to a game player's preferred colors, numbers, shapes, symbols, vehicles, animals, characters, games, music, famous persons, sporting events, hobbies, schools, names, clothes, gender, age or language. Gaming apparatus 20 may also gather information on other topics.

When game players initially begin playing gaming apparatus 20, they may identify themselves by using player tracking cards as is well known in the industry for awarding additional compensation and awards base on player playing times and amounts wagered. After a player has completed playing gaming apparatus 20, a record of the game player's preferences, desires, and tastes that was compiled by gaming apparatus 20 may be stored for future retrieval in player tracking database 98. In this manner, when the game player starts game play on another gaming machine or the same gaming machine at a later time, the game may be automatically customized to the player's preferred game attributes by recalling the customization information from player tracking database 98.

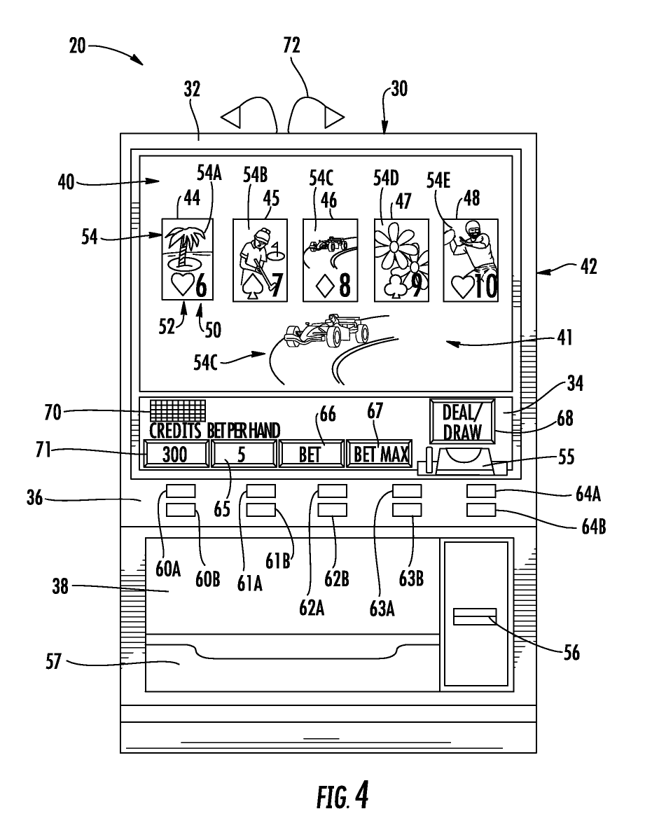

Turning now to FIG. 4, another example of controller 100 (FIG. 2) recording the game player's preference is shown. Twenty hands of video poker are again played on gaming apparatus 20. Controller 100 may record a statistical record of the cards kept as shown in table 2. Table 2 shows that the race car theme 54C was kept most frequently.

TABLE 2

| | Number of |
|---|---|
| Card Theme | Times Kept |
| Tropical island theme 54A | 8 |
| Golf theme 54B | 5 |
| Race car theme 54C | 13 |
| Flower bed theme 54D | 9 |
| Football theme 54E | 7 |

Controller 100 (FIG. 2) then causes video display 40 to display in background 41 race car theme 54C corresponding to the player's preferential theme image. In this manner gaming apparatus 20 may be customized to the game player's preferences and desires without the game player's knowledge or awareness that the game is being customized to his or her personal tastes. In this example, the game parameter that is customized is the background image. Controller 100 may make a statistical record of more or less than 20 hands prior to customizing video display 40 to the game player's preferential image.

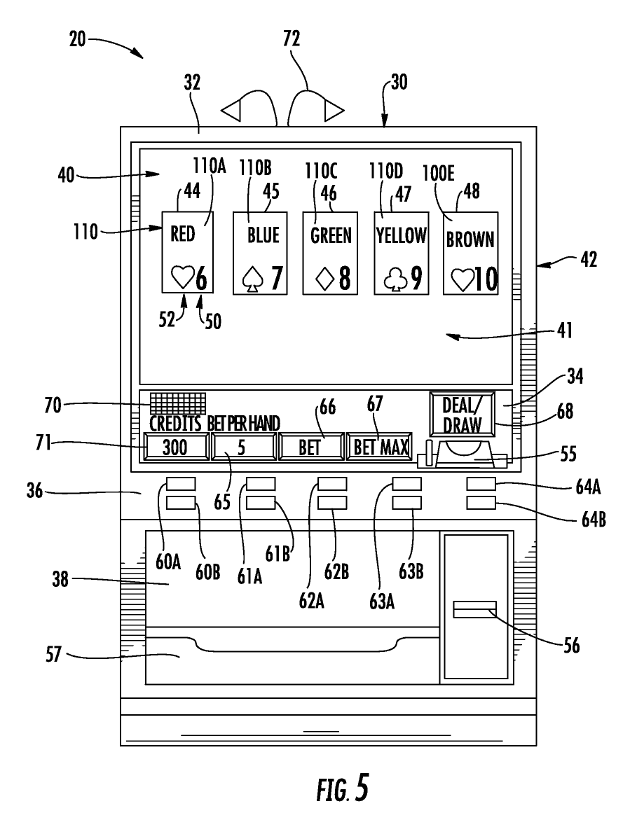

Turning now to FIG. 5, another example of controller 100 (FIG. 2) recording the game player's preference is shown. FIG. 5 is similar to the example shown in FIGS. 3 and 4, except that the player's preferred color is determined instead of an image. Each card in FIG. 5 has a card color 110 in addition to the card value 50 and suit 52. The card colors shown include red 110A, blue 110B, green 110C, yellow 110D and brown 110E. For convenience in portraying the present example, the words corresponding to the colors are printed on the cards in view of the fact that patent drawings are not colored. In reality, the words for the colors would be omitted and the cards would be colored the actual colors on video display 40.

Approximately 20 hands of video poker are again played on gaming apparatus 20. Controller 100 may record a statistical record of the cards kept as shown in table 3. Table 3 shows that the color green 110C was kept most frequently.

TABLE 3

| | Number of |
|---|---|
| Card Color | Times Kept |
| Red 110A | 6 |
| Blue 110B | 10 |
| Green 110C | 15 |
| Yellow 110D | 8 |
| Brown 110E | 4 |

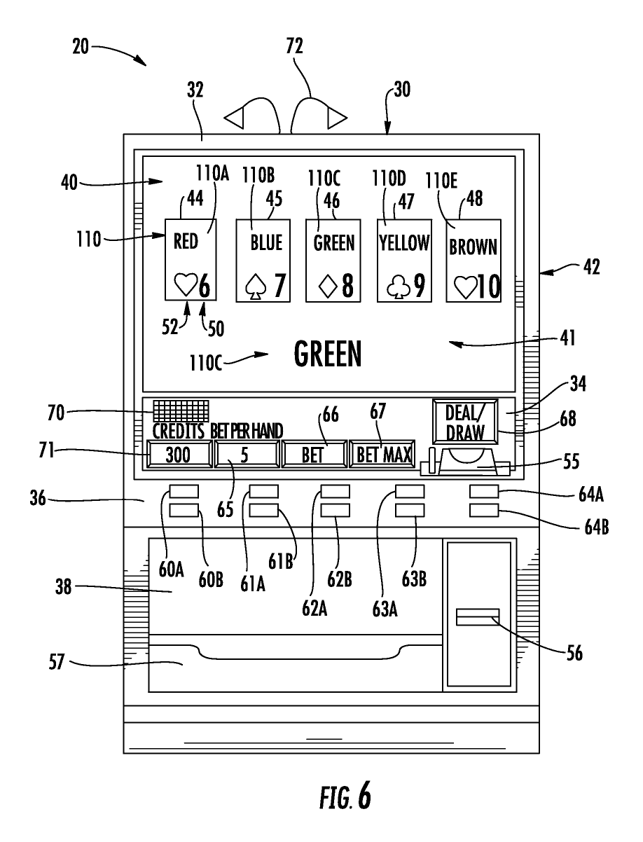

As shown in FIG. 6, controller 100 (FIG. 2) then causes video display 40 to display in background 41 the color green corresponding to the player's preferential color. In this manner gaming apparatus 20 may be customized to the game player's preferred color without the game player's knowledge or awareness that the game is being customized to his or her personal tastes. In this example, the game parameter that is customized is the background color. Controller 100 may make a statistical record of more or less than 20 hands prior to customizing video display 40 to the game player's preferential color.

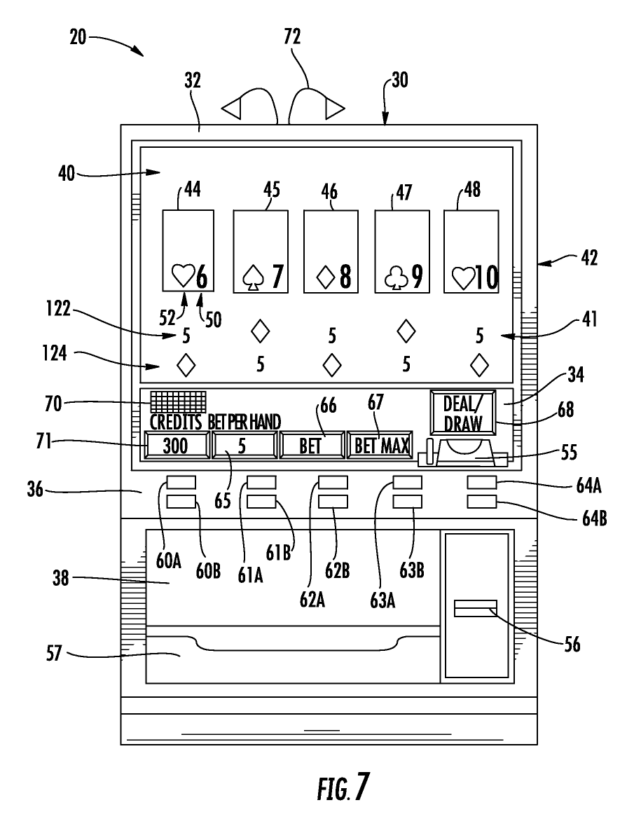

Turning now to FIG. 7, another example of controller 100 recording the game player's preference is shown. FIG. 7 is similar to the example shown in FIGS. 3 and 4, except that the player's preferred card value 50 and suit 52 are determined instead of an image. The cards in FIG. 7 are shown without an image, although an image could be shown on each card.

Approximately 20 hands of video poker are again played on gaming apparatus 20. Controller 100 may record a statistical record in memory 96 of the cards kept as shown in table 4. Table 4 shows that the diamonds and the number 5 were kept most frequently.

TABLE 4

| | Number of | | Number of |
|---|---|---|---|
| Card Value | Times Kept | Card Suit | Times Kept |
| 2 | 4 | Heart | 6 |
| 3 | 3 | Spade | 10 |
| 4 | 5 | Diamond | 15 |
| 5 | 8 | Club | 8 |
| 6 | 4 | | |
| 7 | 3 | | |
| 8 | 6 | | |
| 9 | 1 | | |
| 10 | 4 | | |
| Jack | 6 | | |
| Queen | 3 | | |
| King | 5 | | |
| Ace | 7 | | |

Controller 100 then causes video display 40 to display in background 41, diamond image 124 and the number “5” image 122, which correspond to the player's preferential card value and suit. In this manner gaming apparatus 20 may be customized to the game player's preferred number and card suit without the game player's knowledge or awareness that the game is being customized to his or her personal tastes. In this example, the game parameter that is customized is the background image. Controller 100 may make a statistical record of more or less than 20 hands prior to customizing video display 40 to the game player's preference.

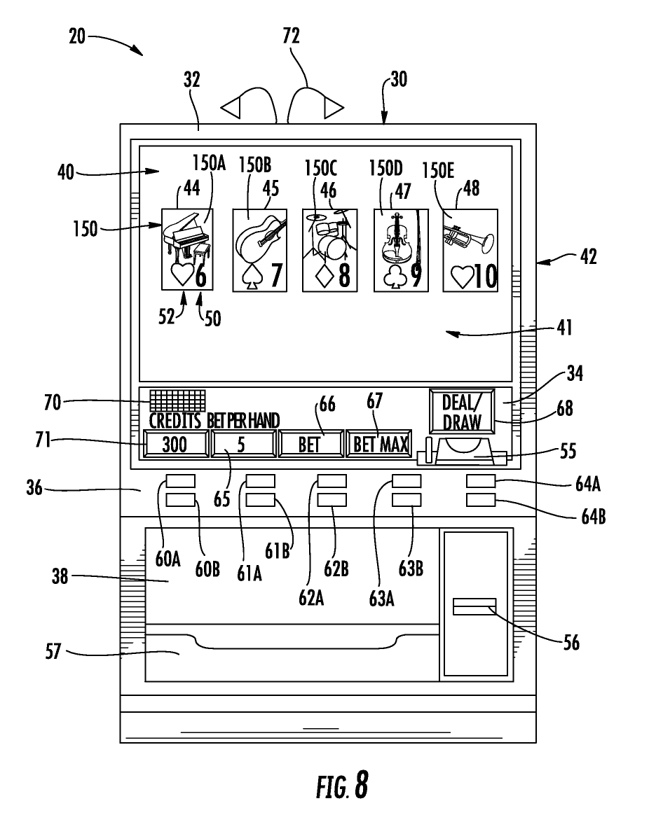

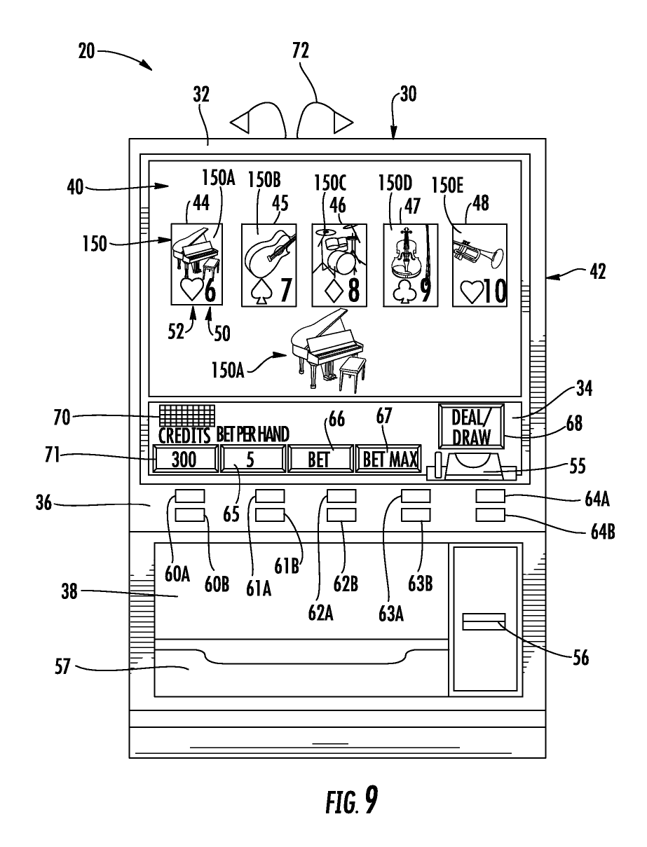

Turning now to FIGS. 8 and 9, another example of controller 100 (FIG. 2) recording the game player's preference is shown. FIG. 8 is similar to the example shown in FIGS. 3 and 4, except that the player's preferred music is determined instead of an image. Each card in FIG. 8 has a musical instrument theme image 150 that is typically associated with a genre of music in addition to the card value 50 and suit 52. The images shown include piano 150A, guitar 150B, drums 150C, violin 150D and horn 150E. Piano 150A can be associated with piano or easy listening music, guitar 150B can be associated with guitar music, drums 150C can be associated with rock and roll music, violin 150D can be associated with classical music and horn 150E can be associated with jazz music.

Approximately 20 hands of video poker are again played on gaming apparatus 20. Controller 100 may record a statistical record of the cards kept as shown in table 5. Table 5 shows that piano image 150A was kept most frequently.

TABLE 3

| | Number of |
|---|---|
| Card Theme | Times Kept |
| Piano 150A | 12 |
| Guitar 150B | 9 |
| Drums 150C | 7 |
| Violin 150D | 8 |
| Horn 150E | 4 |

Referring to FIG. 9, controller 100 (FIG. 2) then causes speaker 70 to play piano music, the game player's preferred music. Various recordings of music may be stored in memory 96. In addition, video display 40 could be changed to display in background 41 the piano image 150A. In this manner, gaming apparatus 20 may be customized to the game player's preferred music without the game player's knowledge or awareness that the game is being customized to his or her personal tastes. In this example, the game parameter that is customized is the audio or music presented during game play.

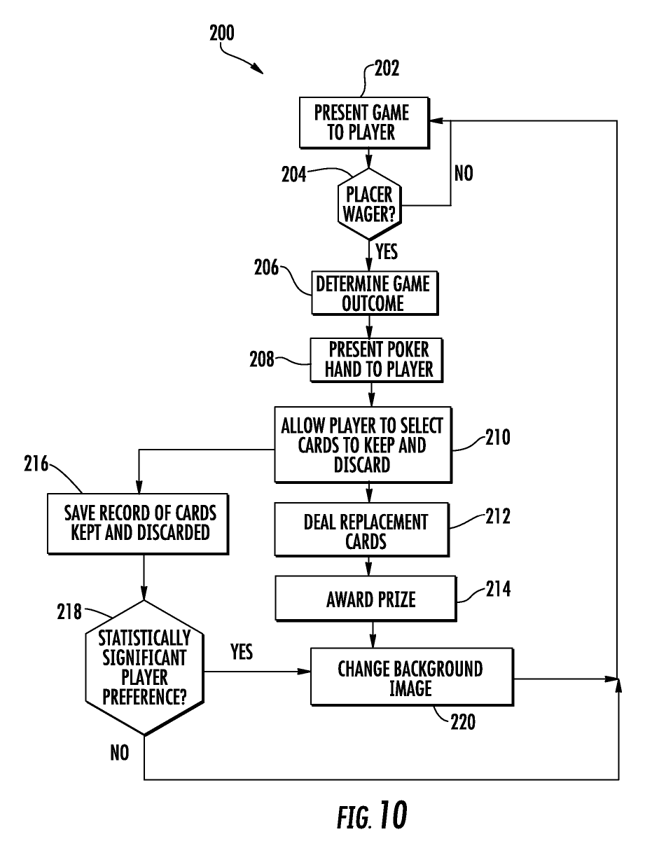

Referring now to FIG. 10, a gaming method 200 using gaming apparatus 20 in accordance with the present invention is shown. Method 200 is illustrated using the example of operating gaming apparatus 20 shown in FIGS. 3 and 4. Method 200 may also be used with the embodiments shown in FIGS. 5-9. At step 202, controller 100 (FIG. 2) may cause a display to be generated on video display 40 to prompt the game player to make a wager at step 202. At decision step 204, controller 100 determines if a wager has been placed. If a wager has not been placed, method 200 returns to step 202. If a wager is entered, method 200 proceeds to step 206. Next, controller 100 determines the game outcome at step 206 using a random number generator (not shown). At step 208, controller 100 deals a virtual poker hand of cards to the player and shows the video poker display 42 on video display 40.

At step 210, the player may be allowed to select which cards to keep and which cards to discard that are replaced with newly drawn cards in an attempt to improve the player's poker hand. At step 212, replacement cards are dealt and displayed to the game player on video display 40. At step 214, any prizes won are awarded to the game player by adding credits to the player's credit meter.

In parallel with step 210, method 200 collects and records which cards are kept and which cards are discarded and the corresponding theme image displayed on the cards at step 216. This data is saved in memory 96 (FIG. 2). At step 218, controller 100 performs a statistical analysis on the cards kept and discarded to determine if the game player has a preferred theme image. Controller 100 can determine if the number of choices is statistically significant. If controller 100 determines that the player has a preferred theme image, method 200 proceeds to step 220 where the background image 41 is changed to the player's preferred theme image. If controller 100 determines that the number of game cycles played is insufficient to determine a preferred theme image, method 200 proceeds to step 202 where the game player is prompted to begin another game by placing a wager.

Therefore, method 200 allows for a game to be customized to the game player's preferred image without the game player's knowledge or awareness that the game is being customized to his or her personal tastes. It is noted that the flowchart in FIG. 10 shows only one possible embodiment. Some of the steps in the flowchart may be varied, changed in order, or eliminated and still fall within the scope of the present invention.

First Bonus Game Embodiment

Turning now to FIG. 1, the present invention further comprises a gaming apparatus, generally indicated by reference number 300. In at least one embodiment, gaming apparatus 300 comprises a bonus gaming device or second display 350 and a primary gaming device 314. Gaming device 314 may be any of a large number of devices that are adapted to allow players to play a game, such as gaming devices typically found in arcade and casino environments, including arcade games, video games, gambling machines, video poker machines, slot machines, etc. In at least one embodiment, gaming device 314 is further adapted to allow a player to place a wager and play a game, such as a slot machine.

Gaming device 314 may include a value acceptor for accepting value (including currency and/or currency equivalents), such as a coin slot 316, card reader 318, or a voucher reader 319. In addition, a payout mechanism (not shown) and a coin receptacle 320 may be provided for awarding prizes or for dispensing value to players cashing out and retiring from a game. A printer (not shown) may also be provided for printing out cashless vouchers (not shown). A handle 322 and a button 324 may be provided for activating gaming device 314 to begin a game. A pay table (not shown) may further be provided to allow a player to see what symbol or combination of symbols provide a winning event. In at least one embodiment, gaming device 314 may be a S2000 or S Plus model gaming device manufactured by International Game Technology in Reno, Nev.

Gaming device 314 may further include a gaming outcome display 328 that may be positioned in front of the gaming device 314 so that a player (not shown) playing gaming device 314 can see gaming outcome display 328. Gaming outcome display 328 may utilize physical game reels 330, 332, and 334. Game reels 330, 332, and 334 may be attached to a drive mechanism (not shown) of gaming device 314 to rotate the reels in a manner well known in the art. Each game reel 330, 332, and 334 may have a plurality of symbols positioned on the circumference of each game reel 330, 332, and 334. Game reels 330, 332, and 334 may be positioned side-by-side with coincident axes of rotation and a portion of their individual circumferences may face outward from gaming device 314.

A panel 336 may cover game reels 330, 332, and 334 such that only a portion of their individual circumferences are shown to the player. At least one symbol from any of game reels 330, 332, and 334 may be used to display a game outcome. At least one pay line 338 may be provided for the player to use in determining a game outcome based on the symbol or a combination of symbols positioned thereon. In an alternative embodiment, gaming outcome display 328 utilizes a video display (not shown) displaying images of game reels and an image of at least one pay line. A video display may also display game symbols in many other formats and arrangements, such as playing cards. Of course, the invention is not limited to any particular type of gaming outcome display 328. Those of skill in the art will recognize that many different types of gaming outcome displays could be substituted without departing from the scope of the present invention.

Gaming device 314 may also be capable of producing a bonus-activating event. This event may be many different types of events. For example, a bonus-activating event may comprise displaying a particular symbol, such as a “bonus” symbol, or combination of symbols, such as three “7” symbols, on reels 330, 332, and 334. If the game being played is poker based, the bonus-activating event may be occurrence of a certain hand, such as a royal flush. Furthermore, a bonus-activating event may occur when a player accumulates a number of symbols or game outcomes over a number of separate game plays. For example, a bonus-activating event may occur when the player receives three “bonus” symbols during a period of time. The bonus-activating event may be based on an external event. For example, a bonus-activating event may occur when a group of players obtain a certain result.

Gaming apparatus 300 may include a bonus gaming device or a second display 350 configured to display at least one game and prize to a player. In at least one embodiment, second display 350 is configured to display a bonus game and at least one bonus prize to the player. In other embodiments, second display 350 may provide a primary game. Alternatively, second display 350 may be a stand-alone device (not shown) allowing a player to place a wager and play a game.

In at least one embodiment, second display 350 is attached to gaming device 314 and positioned on top of gaming device 314. In other embodiments (not shown), second display 350 may be separate from gaming device 314 but in communication with gaming device 314. In this embodiment, second display 350 may be in communication with a plurality of different gaming devices 314 via a computer network in a manner that is well known in the art. Second display 350 may also be positioned adjacent to or remote from gaming device 314. In other embodiments, second display 350 is a stand-alone display not in communication with gaming device 314, and it may be capable of independently accepting wagers, conducting games, and awarding prizes to a player.

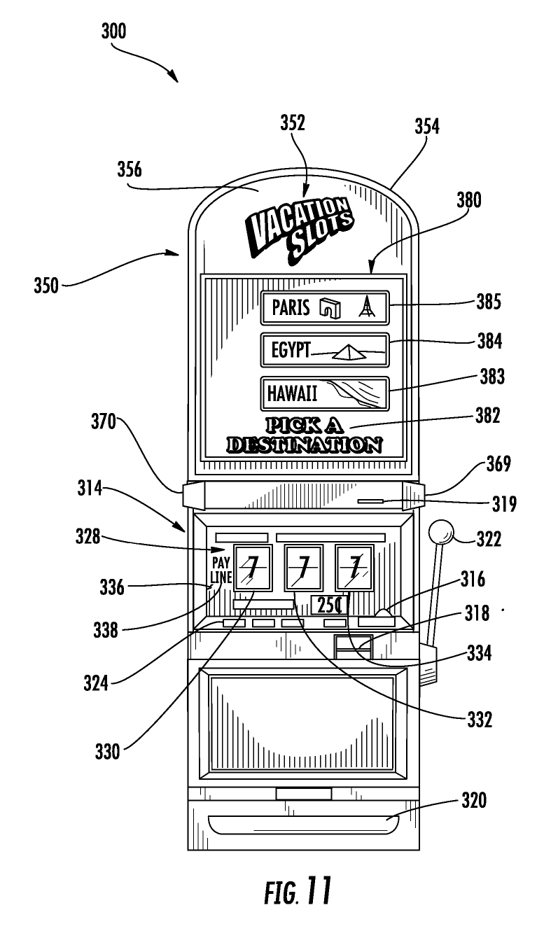

With continued reference to FIG. 11, second display 350 may comprise game display 352 mounted in a housing 354. Housing 354 may have a plurality of walls defining an internal space or cavity. Housing 354 may be made in many different shapes. Housing 354 can have a front panel 356. A video display 380 can be mounted in front panel 356. Video display 380 may be an LCD, Plasma or CRT display. Video display 380 may also be a touch screen display. Video display 380 may be in communication with a controller and can be configured to present or show a wide variety of video presentations.

As shown in FIG. 11, video display 380 can present to a game player several selections for the player to choose from. The selections can be related to the theme of a game. In the example shown, a travel or vacation theme is shown. Other themes can be shown such as monetary amounts, vehicles or furniture.

Several travel or vacation destinations can be shown on touch screen locations on video display 380. Touch screen location 383 shows a travel destination of Hawaii. Touch screen location 384 shows a travel destination of Egypt. Touch screen location 385 shows a travel destination of Paris, France. Screen location 382 requests that the player select or pick one of the travel destinations. The player can choose one of the destinations by pressing on one of the touch screen locations 383, 384 or 384.

If the game player does not choose one of the travel destinations, after a pre-determined period of time, game apparatus 300 may automatically select one of the travel destinations for the game player.

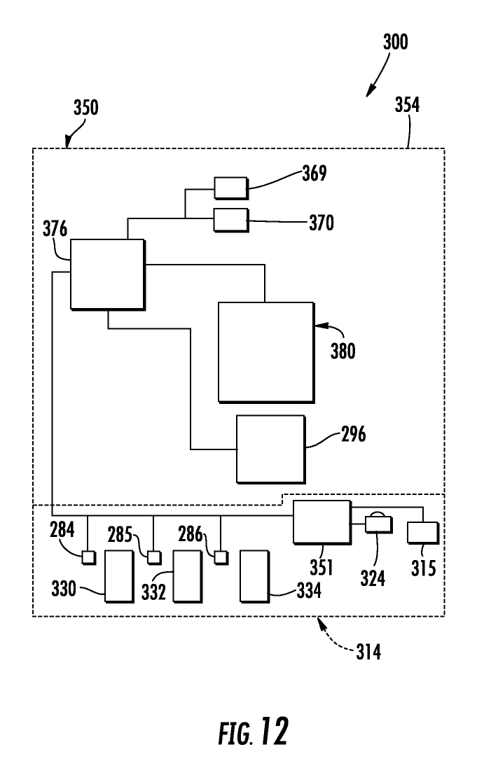

Referring now to FIG. 12, a schematic diagram of some components that may be included in certain embodiments of gaming apparatus 300 is shown. Gaming device 314 may include a value acceptor 315 configured to accept value from the player in the form of paper currency, coins, player cards, tickets, vouchers, tokens, or other forms of value. Value acceptor 315 may include coin slot 316, card reader 318 and voucher reader 319 (FIG. 11). Value acceptor 315 may be in communication with controller 351. Controller 351 may be in communication with an input device 324. Controller 351 may detect insertion of value into value acceptor 315 and may prompt the player to start a game by activating input device 324. Once controller 351 senses a signal to start the game, controller 351 may be configured to produce a random number and activate game reels 330, 332 and 334 of gaming device 314. Game reels 330, 332 and 334 may be configured to display indicia (including symbols, characters, numbers, letters, pictures, and the like) according to the random number generated by controller 351. Alternatively, controller 351 may be configured to produce a random number and activate a video display (not shown) of the reels. The primary game of gaming device 314, whether in physical form or in video form, is not limited to reel-type games, but may include card games, dominoes, roulette, craps, baccarat, and other games.

Bonus gaming device 350 can include a controller 376 that is configured to control the operation of the device. Controller 376 may be one or more computers (not shown) or processor boards (not shown). Controller 376 may be in communication with controller 351.

Controller 376 is configured to detect when a bonus activating event occurs in gaming device 314. This may be accomplished by game apparatus controller 351 transmitting a signal to controller 376 that a bonus event has occurred. For example, controller 351 may determine the outcome of each game, and when a bonus-activating outcome occurs, it transmits a signal to controller 376. Alternatively, controller 376 may periodically interrogate controller 351. In another embodiment, one or more sensors 284, 285, and 286 may be provided for determining if a bonus activating event has occurred. For example, sensors 284-286 may sense the positions of game reels 330, 332 and 334. When reels 330, 332 and 334 are in a bonus activating position, controller 376 would sense this position and begin a bonus sequence.

When controller 376 detects a bonus-activating event, it may begin a bonus sequence by activating display 380. Display 380 may comprise many different kinds of display devices, such as video screens, lights and light emitting diodes (LED). Display 380 may comprise its own controller (not shown) that is configured to generate a variety of displays. Controller 376 may also activate speakers 69 and 70 and various lights (not shown).

Display 380 may indicate that a player has qualified for a bonus round and prompt the player to make a selection as shown in FIG. 11. In one embodiment, the player is prompted to select a vacation destination using a touch screen display.

With continued reference to FIG. 12, controller 376 may generate a random number to determine a game outcome. Controller 376 can produce a random or pseudo random number for each game. The outcome of the game may be determined by comparing the random number produced to a table of outcomes stored in a memory (not shown) and accessed by controller 376. A number of different tables of outcomes may be used and different tables may be used for different games. The tables can be designed so that different prizes have different probabilities of being awarded. Such design techniques are well known in gaming and are described above. Examples of such designs are shown in U.S. Pat. No. 4,448,419, issued to Telnaes, and U.S. Pat. No. 5,456,465, issued to Durham, which are hereby incorporated by reference.

The bonus prize may be determined by controller 376 and a virtual pay table, such as the pay table described in U.S. Pat. No. 5,823,874 to Adams, which is hereby incorporated by reference. A simple pay table may also appear as follows:

TABLE 1

| Random Number | Amount Paid |
|---|---|
| 0.00 to 0.50 | $5.00 |
| 0.51 to 0.75 | $10.00 |
| 0.76 to 0.90 | $20.00 |
| 0.91 to 0.98 | $100.00 |
| 0.99 to 1.00 | Vacation |

For example, if the random number generator produced 0.32 as the game outcome, the controller would cause display 380 to display a prize of $5.00. The controller may then award any credits won and cause the credits to be added to the credit meter.

The present invention is not limited to the example pay table shown. Furthermore, different kinds of bonus prizes may be awarded, such as progressive prizes, jackpot prizes, merchandise, services, prize multipliers, and additional games.

Other effects may also be presented, such as pre-recorded sound from speakers 369 and 370. Speakers 369 and 370 may be configured to announce a prize a player has won, play music during a prize winning event, announce features of the game offered by gaming apparatus 300, or play music to attract and entertain patrons. Additionally, a variety of graphics and lights, preferably designed according to a particular theme can be displayed on display 380. For example, if the player is awarded a trip to Hawaii, Hawaiian music can be played and images of Hawaii shown on display 380.

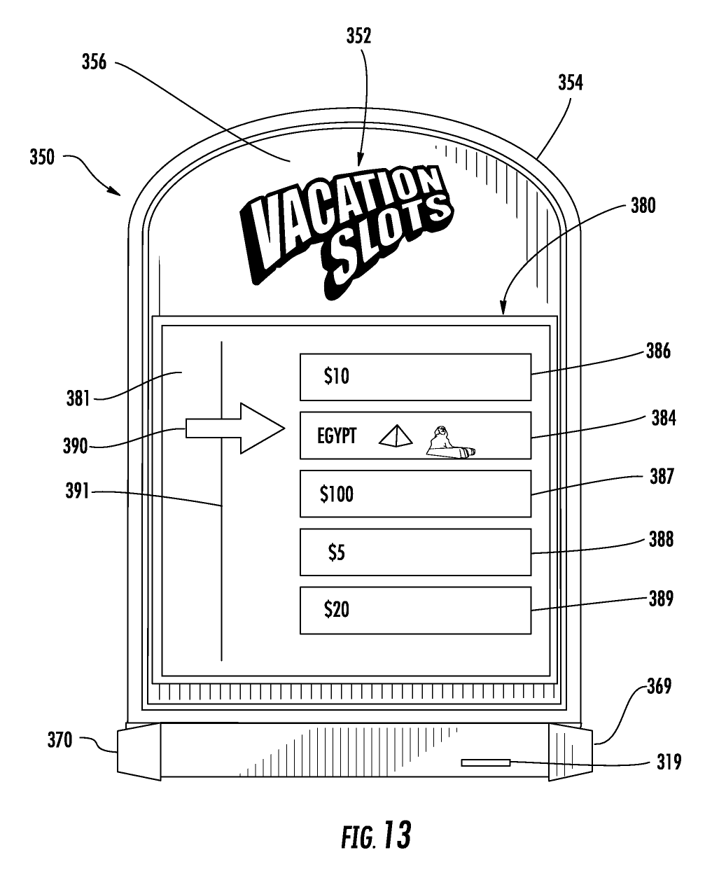

Referring to FIG. 13, bonus gaming device or second display 350 is shown after the game player has selected a travel or vacation destination. In FIG. 13, the game player has selected Egypt as their preferred travel or vacation destination. In FIG. 13, screen display 381 displays the vacation destination of Egypt 384 along with other possible monetary prizes 386, 387, 388 and 389 to the game player. Screen display 381 also includes a pointer or indicator 390 that can be made to move in the video presentation up and down on a track 391. Indicator 390 can be made to move and then stop at the prize or game outcome previously selected by controller 376 (FIG. 12). Indicator 390 could also be a physical mechanical indicator.

In FIG. 13, indicator 390 is shown pointing to a trip to Egypt indicating that the game player has won a trip to their preferred travel destination. Therefore, gaming apparatus 300 has been customized to the game player's preferred travel destination. In this example, the game parameter that is customized is the player's desired travel or vacation destination.

The game player's customization information can be stored for future retrieval in a player tracking database 296 (FIG. 12). In the future, when the game player returns to the machine and inserts a player tracking card, gaming apparatus 300 can begin game play by displaying the game player's preferred travel destination.

If the awarded bonus prize is money, the amount of the bonus prize may be added to the player's credit meter (not shown). If the awarded prize is a trip or vacation, an attendant may be summoned to award the prize to the player.

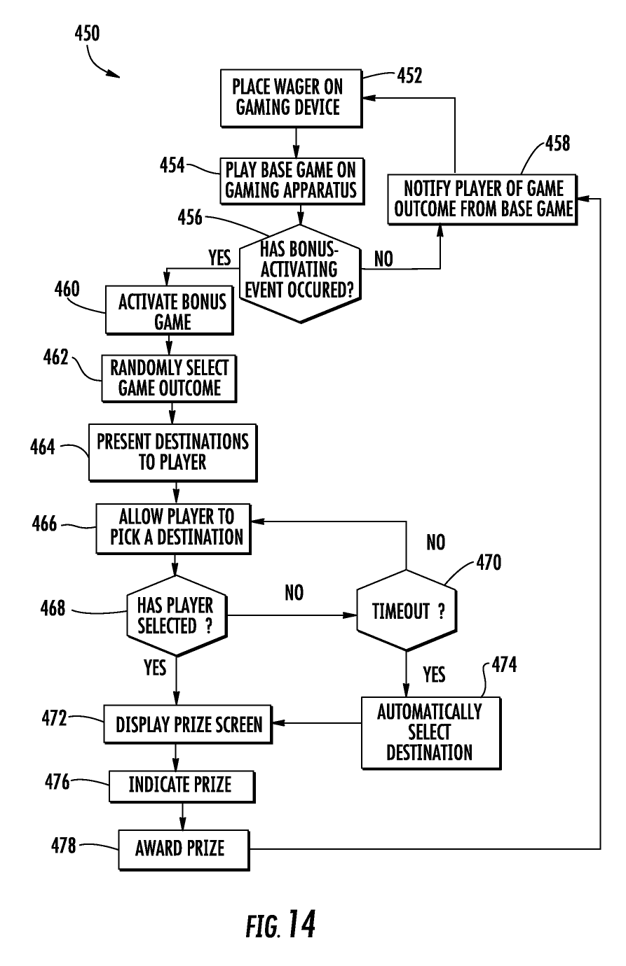

A method 450 of playing gaming apparatus 300 is shown in FIG. 14. A player is allowed to place a wager on gaming apparatus 300 in step 452. At step 454, the player plays a base or primary game on the gaming apparatus. At decision 456, method 450 checks to see if the game outcome from the base game is an bonus activating event or an outcome qualifying the player to play a bonus game. If not, method 450 proceeds to step 458 and awards the player any prizes awarded according the game outcome determined in step 454 and returns to step 452.

If it is determined in step 456 that the game outcome of step 456 qualifies the player for a bonus game, method 450 proceeds to step 460. At step 460, the bonus game or second display 350 (FIG. 11) is activated. Next, method 450 proceeds to randomly determine a game outcome at step 462.

At step 464, various travel destinations are presented to the game player on the video display. The player is allowed to pick a travel destination at step 466. At decision 468, method 450 checks to see if the game player has made a selection. If not, method 450 proceeds to step 470 to determine if a pre-determined period of time has transpired. If the time has exceeded the time to make a selection, method 450 proceeds to step 474, where one of the travel destinations are automatically selected. If the elasped time is less than the allocated time to make a selection, method 450 returns to step 466 and waits for player input.

If it is determined in decision 468 that the player has provided input, method 450 proceeds to step 472. At step 472, the video display presents the possible prizes including the travel destination selected by the game player. At step 476, the controller causes indicator 390 (FIG. 13) to display the game outcome. Any prizes may be awarded at step 478 before method 450 returns to step 458.

Various additions, subtractions, and permutations of the steps in the above described methods can be made without departing from the scope of the present invention. For example, the player may be allowed to select both the travel destination and the monetary amounts (although not the final prize awarded). The more the player is allowed to interact with gaming apparatus 300, the more customization of the game the player may feel, which may make the game more enjoyable to the player. Regulatory concerns may dictate that at least a portion of the player's perceived customization be illusionary.

Second Bonus Game Embodiment

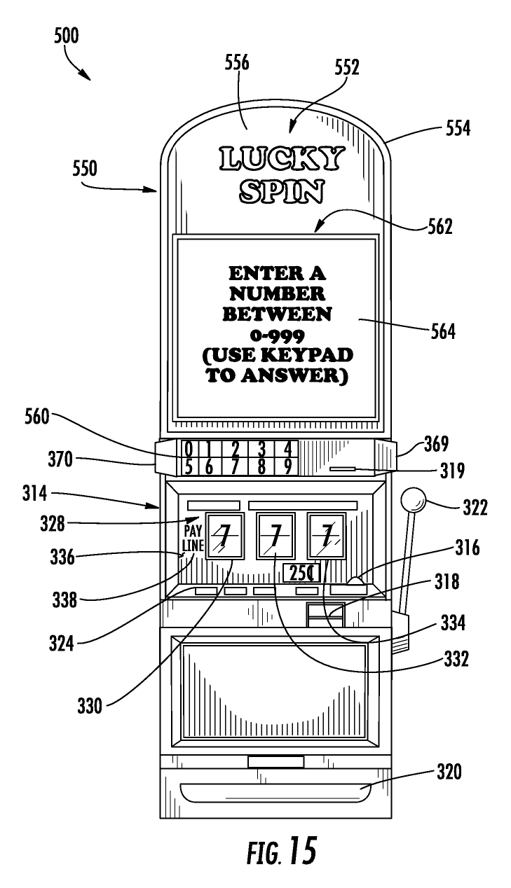

With reference now to FIG. 15, an additional gaming apparatus 500 is shown. Gaming apparatus 500 has some similarities with gaming apparatus 300. Gaming apparatus 500 can include primary gaming device 314 and a bonus gaming device or second display 550. Bonus gaming device 550 may be configured to display at least one bonus game and prize to a player. In at least one embodiment, second display 550 is configured to display a bonus game and at least one bonus prize to the player. In other embodiments, second display 550 may provide a primary game. Alternatively, second display 550 may be a stand-alone device allowing a player to place a wager and play a game.

In at least one embodiment, second display 550 is attached to gaming device 314 and positioned on top of gaming device 314. In other embodiments (not shown), second display 550 may be separate from gaming device 314 but in communication with gaming device 314. In another embodiment, second display 550 may be in communication with a plurality of different gaming devices (not shown) via a computer network (not shown) in a manner that is well known in the art. Second display 550 may also be positioned adjacent to or remote from gaming device 314.

With continued reference to FIG. 15, second display 550 may comprise a game display 552 mounted in a housing 554. Housing 554 may have a plurality of walls defining an internal space or cavity. Housing 554 may be made in many different shapes. Housing 554 can have a front panel 556. A video display 562 can be mounted in front panel 556. Video display 562 may be an LCD, Plasma or CRT display. Video display 562 may also be a touch screen display. Video display 562 may be in communication with a controller and can be configured to present or show a wide variety of video presentations.

Bonus gaming device or second display 550 may further include a player input device or keypad 560. Keypad 560 has buttons or pads corresponding to the numbers 0 through 9. Keypad 560 would be in communication with controller 376 (FIG. 12). Keypad 560 can be used by a game player to input numbers to controller 376. Alternatively, video display 562 may include a touch screen display that could also be used to input various numbers to controller 376.

As shown in FIG. 15, video display 562 can present a screen 564 to a game player that requests the game player to enter or select a number between 0 and 999. The player is prompted to enter the number using keypad 560. The number entered by the player may be the game player's favorite number, lucky number, birthday, age or any other number that the player selects between 0 and 999.

If the game player does not select a number, after a predetermined period of time, second display 550 may automatically select a number for the game player.

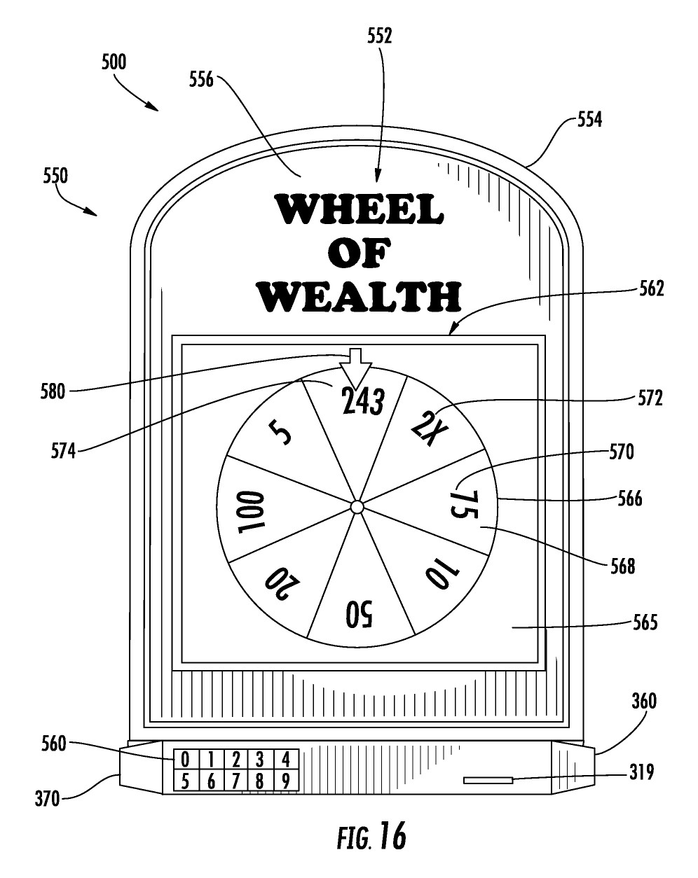

Turning to FIG. 16, second display 550 is shown after the game player has selected a number. In FIG. 16, video display 562 is shown displaying a screen display 565. Screen display 565 includes a segmented wheel 566 having several sections or segments 568. Wheel 566 may be made to appear to spin or rotate on video display 562. Various indicia 570 are shown in each of segments 568. Indicia 570 can be numbers or may be multiplier awards 572 that would be multiplied by the player's winnings in the primary game.

Also shown in one of segments 568 is the player's number 574 that was selected by the game player using keypad 560 as described in FIG. 15. Each of the numbers shown in segments 568 represents a possible prize that may be selected by controller 376 (FIG. 12) to be awarded to the game player as a prize. One of the possible prizes is the number 574 selected by the game player.

Screen display 565 also includes a fixed pointer or indicator 580 that can indicate one of the indicia as a prize. Wheel 566 can be made to appear to rotate and then stop. Indicator 580 indicates the prize or game outcome previously selected by controller 376. Indicator 580 could also be a physical mechanical indicator.

In FIG. 16, indicator 580 is shown pointing to indicium 574, the player's selected number having a value of “243”. The player has won in credits the amount of their selected number. Therefore, gaming apparatus 500 has been customized to the game player's preferred or selected number. In this example, the game parameter that is customized is the player's preferred number.

The game player's customization information can be stored for future retrieval in a player tracking database 296 (FIG. 12). In the future, when the game player returns to the machine and inserts a player tracking card (not shown), gaming apparatus 500 can begin game play by displaying the game player's preferred number on wheel 566. The awarded bonus prize may be added to the player's credit meter (not shown).

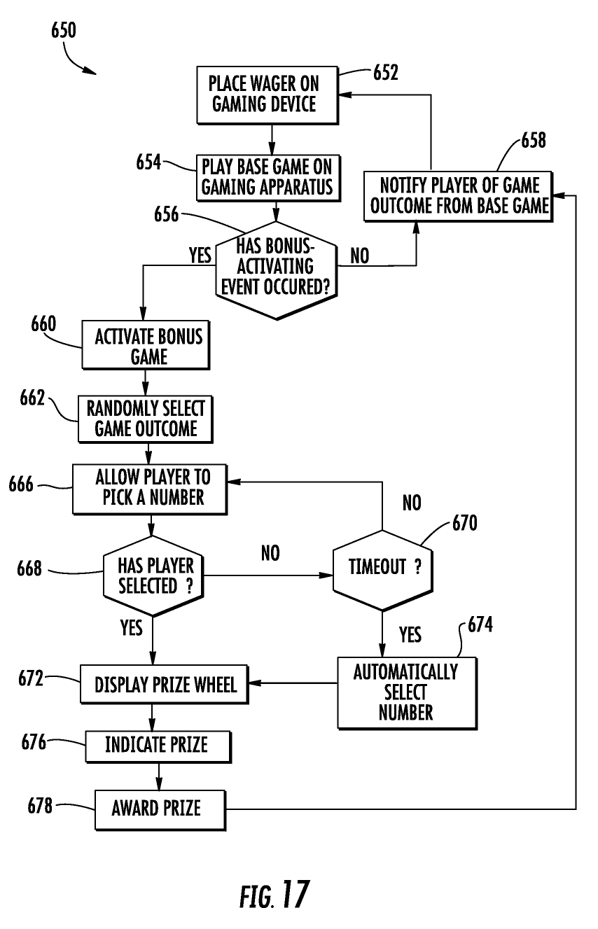

A method 650 of playing gaming apparatus 500 is shown in FIG. 17. A player is allowed to place a wager on gaming apparatus 500 in step 652. At step 654, the player plays a base or primary game on the gaming apparatus. At decision 656, method 650 checks to see if the game outcome from the base game is an bonus activating event or an outcome qualifying the player to play a bonus game. If not, method 650 proceeds to step 658 and awards the player any prizes awarded according the game outcome determined in step 654 and returns to step 652.

If it is determined in step 656 that the game outcome of step 656 qualifies the player for a bonus game, method 650 proceeds to step 660. At step 660, the bonus game or second display 550 (FIG. 15) is activated. Next, method 650 proceeds to randomly determine a game outcome at step 662.

At step 664, the player is allowed to pick or select a number. At decision 668, method 650 checks to see if the game player has made a selection. If not, method 650 proceeds to step 670 to determine if a pre-determined period of time has transpired. If the time has exceeded the time to make a selection, method 650 proceeds to step 674, where a number is automatically selected. If the elapsed time is less than the allocated time to make a selection, method 650 returns to step 666 and waits for player input.

If it is determined in decision 668 that the player has selected a number, method 650 proceeds to step 672. At step 672, the prize wheel 566 (FIG. 16) is shown with possible prizes including the number of credits selected by the game player. At step 676, the controller causes wheel 566 and indicator 580 (FIG. 16) to display the game outcome. Any prizes may be awarded at step 678 before method 650 returns to step 658.

Various additions, subtractions, and permutations of the steps in the above described methods can be made without departing from the scope of the present invention. For example, the player may be allowed to select more than one number to be displayed as possible prizes on wheel 566. The more the player is allowed to interact with gaming apparatus 500, the more customization of the game the player may feel, which may make the game more enjoyable to the player. Of course, regulatory concerns may dictate that the player's perceived customization be largely or completely illusionary.

Third Bonus Game Embodiment

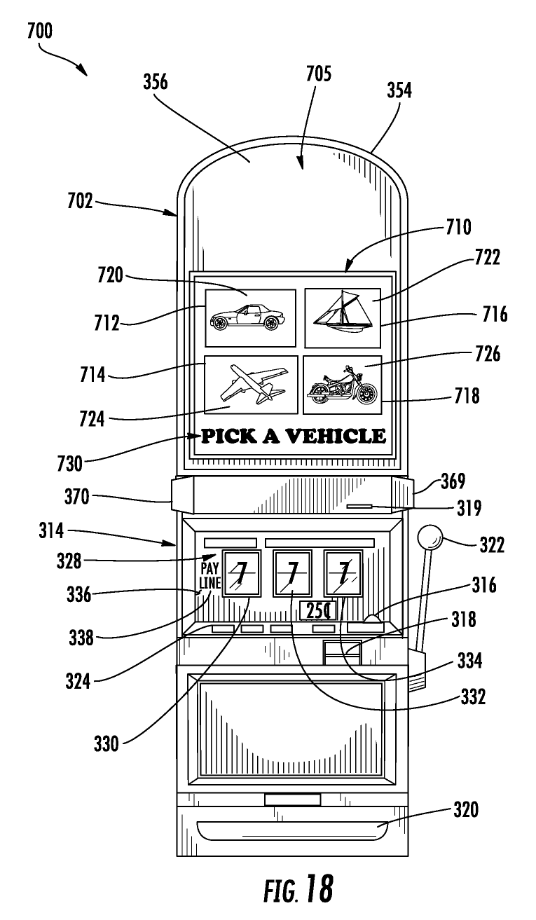

With reference now to FIG. 18, an additional gaming apparatus 700 is shown. Gaming apparatus 700 has some similarities with gaming apparatus 300. Gaming apparatus 700 can include primary gaming device 314 and a bonus gaming device or second display 702. Second display 702 may be configured to display at least one bonus game and prize to a player. In at least one embodiment, second display 702 is configured to display a bonus game and at least one bonus prize to the player. In other embodiments, second display 702 may provide a primary game. Alternatively, second display 702 may be a stand-alone device allowing a player to place a wager and play a game.

In at least one embodiment, second display 702 is attached to gaming device 314 and positioned on top of gaming device 314. In other embodiments (not shown), second display 702 may be separate from gaming device 314 but in communication with gaming device 314.

With continued reference to FIG. 18, second display 702 may comprise game display 705 mounted in a housing 354. Housing 354 may have a plurality of walls defining an internal space or cavity. Housing 354 may be made in many different shapes. Housing 354 can have a front panel 356. A video display 710 can be mounted in front panel 356. Video display 710 may be an LCD, Plasma or CRT display. Video display 710 may also be a touch screen display. Video display 710 may be in communication with a controller and can be configured to present or show a wide variety of video presentations.

As shown in FIG. 18, video display 710 can present to a game player several symbols or selections for the player to choose from. The selections can be related to the theme of a game. In the example shown, methods of transportation or a vehicle theme is shown.

Several vehicles or modes of transportation can be shown on touch screen locations on video display 710. Touch screen location 712 shows a car 720. Touch screen location 714 shows an airplane 724. Touch screen location 716 shows a sailboat 722. Screen location 718 shows a motorcycle 726. Screen location 730 requests that the player select or pick one of the vehicles. The player can choose one of the vehicles by pressing on one of the touch screen locations 712, 714, 716 or 718.

If the game player does not choose one of the vehicles, after a pre-determined period of time, game apparatus 700 may automatically select one of the vehicles for the game player.

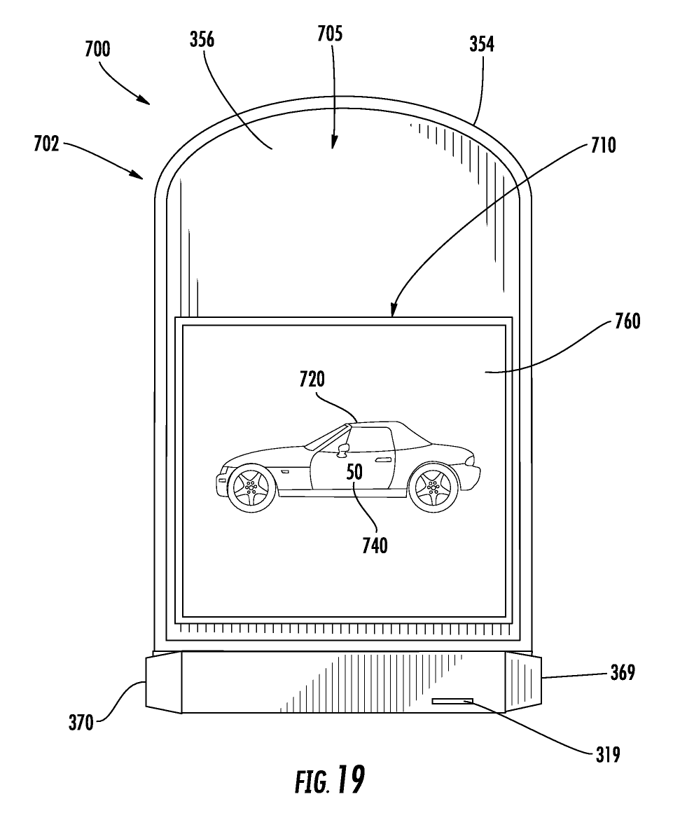

Turning to FIG. 19, gaming device 700 is shown after the game player has selected a vehicle. In FIG. 19, video display 710 is shown displaying a screen display 760. The player has selected car 720 as their preferred vehicle. Screen display 760 includes car 720 that is displaying the game outcome indicia 740. Indicia 740 can be a number or may be a multiplier award that would be multiplied by the player's winnings in the primary game. Indicia 740 may also be other prizes such as physical prizes such as a free dinner or hotel stay. The amount of indicia 740 may be added to the player's credit meter. Car 720 may be made to move or drive around video display 710 in an entertaining manner before or after indicia 740 is shown.

In FIG. 19, car 720 is shown displaying indicia 740 having a value of “50” credits. The credits may be added to the player's credit meter. Therefore, gaming device 700 has been customized to the game player's preferred or selected vehicle. In this example, the game parameter that is customized is the player's favorite vehicle.

The game player's customization information can be stored for future retrieval in a player tracking database 296 (FIG. 12). In the future, when the game player returns to the machine and inserts a player tracking card (not shown), gaming apparatus 700 can begin game play by displaying the game player's preferred vehicle on video display 710.

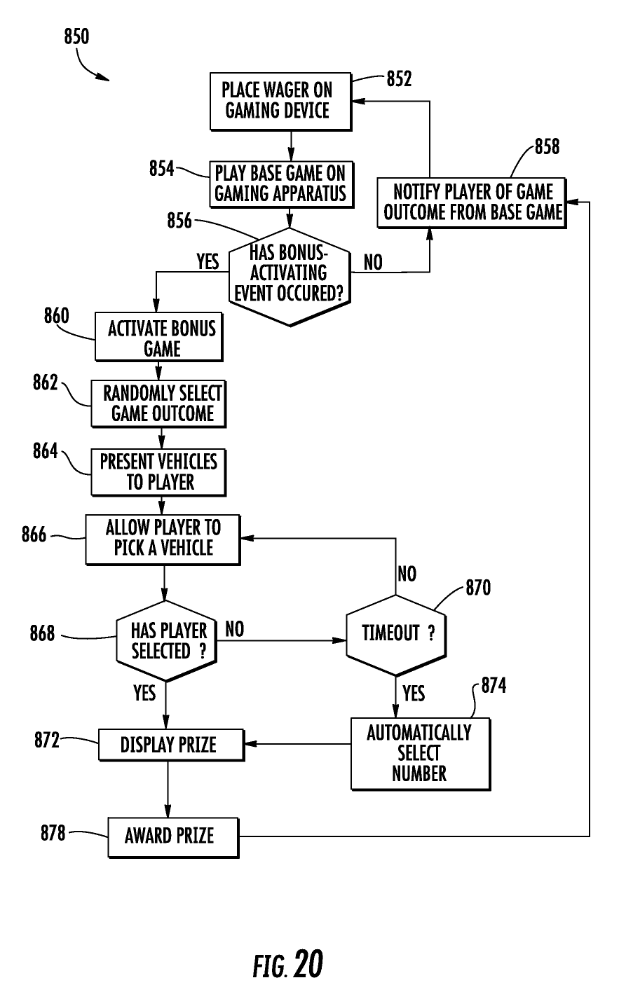

A method 850 of playing gaming apparatus 700 is shown in FIG. 20. A player is allowed to place a wager on gaming apparatus 700 in step 852. At step 854, the player plays a base or primary game on the gaming apparatus. At decision 856, method 850 checks to see if the game outcome from the base game is an bonus activating event or an outcome qualifying the player to play a bonus game. If not, method 850 proceeds to step 858 and awards the player any prizes awarded according the game outcome determined in step 854 and returns to step 852.

If it is determined in step 856 that the game outcome of step 854 qualifies the player for a bonus game, method 850 proceeds to step 860. At step 860, the bonus game or second display 702 (FIG. 18) is activated. Next, method 850 proceeds to randomly determine a game outcome at step 862.

Several vehicles or modes of transportation are presented to the game player in step 864. At step 866, the player is allowed to pick or select a vehicle. At decision 868, method 850 checks to see if the game player has made a selection. If not, method 850 proceeds to step 870 to determine if a pre-determined period of time has transpired. If the time has exceeded the time to make a selection, method 850 proceeds to step 874, where a vehicle is automatically selected. If the elapsed time is less than the allocated time to make a selection, method 850 returns to step 866 and waits for player input.

If it is determined in decision 868 that the player has selected a vehicle, method 850 proceeds to step 872. At step 872, the game outcome or prize is displayed using the vehicle selected by the game player. Any prizes may be awarded at step 878 before method 850 returns to step 858.

Various additions, subtractions, and permutations of the steps in the above described methods can be made without departing from the scope of the present invention. For example, the player may be allowed to select more than one vehicle or may be allowed to move the selected vehicle on the video screen using a device such as a joystick. The more the player is allowed to interact with gaming apparatus 700, the more customization of the game the player may feel, which may make the game more enjoyable to the player.

### Conclusion

It can thus be realized that certain embodiments of the present invention provide a highly attractive and entertaining device for displaying prizes. Certain embodiments of the present invention further provide gaming device that has game parameters that can be customized or modified to a player's preference. Certain embodiments may further cause players to play longer because the display device enhances the anticipation, stimulation, and excitement experienced by players.

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A gaming device comprising:
(A) a game apparatus, the game apparatus being adapted to allow a player to play a game, the game apparatus having at least one game parameter; and
(B) a controller in communication with the game apparatus, the controller being adapted to gather player profile information during game play and to modify the at least one game parameter during game play based upon the player profile information.

2. The gaming device of claim 1 wherein the player profile information is gathered during game play without the player's knowledge.

3. The gaming device of claim 1 wherein the player profile information is collected during a selection made by the player.

4. The gaming device of claim 1 wherein a player input device is in communication with the controller, the player input device allowing the player to make a selection.

5. The gaming device of claim 1 wherein the player profile information is stored for future retrieval.

6. The gaming device of claim 1 wherein the player profile information is selected from the group consisting of:
a) colors;
b) numbers;
c) shapes;
d) symbols;
e) vehicles;
f) animals;
g) characters;
h) games;
i) music
j) famous persons;
k) sporting events;
l) hobbies;
m) schools;
n) names;
o) clothes;
p) gender;
q) age; and
r) language.

7. The gaming device of claim 1 wherein a statistical analysis is performed on the player profile information in order to determine the at least one game parameter to be modified.

8. A method of playing a game, but not necessarily in the order shown, comprising:
a) allowing a game player to play a game on a gaming device;
b) gathering player preference information from a game player during the game in a covert manner such that the game player is unaware of the information gathering; and
c) modifying the game based upon the player preference information.

9. The method of claim 8 further comprising: storing the player preference information.

10. The method of claim 9 further comprising
a) identifying a player;
b) retrieving the player preference information associated with the player; and
c) modifying the game based upon the stored player preference information.

11. The method of claim 8 wherein the player preference information is gathered during a bonus game.

12. The method of claim 8 further comprising:
a) performing a statistical analysis of the player preference information; and
b) selecting a game parameter to be modified.

13. A gaming method comprising, but not necessarily in the order shown:
(A) providing a gaming device;
(B) allowing a player to place a wager on the gaming device;
(C) presenting the player with a first set of possible prizes;
(D) allowing the player to choose a first possible prize from the first set of possible prizes;
(E) determining a game outcome;
(F) displaying to the player a second set of possible prizes, the second set of possible prizes at least including the first possible prize; and
(G) indicating at least one of the second set of possible prizes as the game outcome.

14. The method of claim 13 further comprising:
(A) providing a player input device; and
(B) allowing the player to choose the first possible prize using the player input device.

15. The method of claim 13 wherein the first set of possible prizes is selected from the group consisting of
a) vacations;
b) monetary amounts;
c) vehicles; and
d) furniture.

16. A gaming device comprising:
(A) a game apparatus, the game apparatus being adapted to allow a player to play a game, the game apparatus having a plurality of game symbols; and
(B) a controller in communication with the game apparatus, the controller being adapted to determine a prize and to display the game symbols to the player;
(C) an input device in communication with the controller, the input device allowing the player to select a first game symbol from the plurality of game symbols, the controller further adapted to display the prize to the player using the first game symbol.

17. The gaming device of claim 16 wherein the first game symbol is selected during game play without the player's knowledge.

18. The gaming device of claim 16 wherein the first game symbol is selected during game play with the player's knowledge.

19. The gaming device of claim 16 wherein the first game symbol is associated with the player and stored for future retrieval.

20. A gaming method comprising, but not necessarily in the order shown:
(A) providing a gaming device;
(B) allowing a player to place a wager;
(C) determining a game outcome, the game outcome being conveyable by at least one indicia;
(D) displaying a plurality of objects;
(E) allowing the player to select at least one of the objects; and
(F) displaying the indicia on the selected object.

21. The method of claim 20 further comprising:
a) repeating allowing the player to select at least one object;
b) performing a statistical analysis of the player selection; and
c) determining a preferred selected object.

22. The method of claim 20 wherein the selected object is determined in a covert manner without the player's knowledge

23. A gaming device comprising:
(A) display means for displaying a plurality of symbols in a first location;
(B) selection means for allowing a player to select at least one of the symbols during a game; and
(C) controller means for determining a preferred symbol and displaying the preferred symbol at a second location on the display means.

24. The gaming device of claim 23 wherein the controller means performs a statistical analysis to determine the preferred symbol.

25. The gaming device of claim 23 wherein the symbol is selected from the group consisting of:
a) colors;
b) numbers;
c) shapes;
d) symbols;
e) vehicles;
f) animals;
g) characters;
h) games;
i) music;
j) famous persons;
k) sporting events;
l) hobbies;
m) schools;
n) names;
o) clothes;
p) gender;
q) age; and
r) language.

26. The gaming device of claim 23 wherein the preferred symbol displays a prize.

27. A gaming device comprising:
a) game apparatus means for allowing a player to play a game, the game apparatus means having at least one game parameter;
b) player input means for allowing the player to make a selection;
c) controller means in communication with the game apparatus means and the player input means, the controller means recording the player's selection during game play and modifying the at least one game parameter based upon the player's selection.

28. The gaming device of claim 27 wherein a statistical analysis is performed on the player's selections in order to determine the at least one game parameter to be modified.

29. The gaming device of claim 27 wherein the game parameter is different than the selection.

30. The gaming device of claim 27 wherein the game player is not aware of the game
